(19) United States
(12) Patent Application Publication
(10) Pub. No.: US 2009/0116660 A1
(43) Pub. Date: May 7, 2009

(54) In-Band Parametric Sound Generation System

(75) Inventors: James J. Croft, III, San Diego, CA (US); Wensen Liu, San Diego, CA (US); Elwood G. Norris, Poway, CA (US)

Correspondence Address: THORPE NORTH & WESTERN, LLP., P.O. Box 1219, SANDY, UT, 84091-1219, US

(73) Assignee: AMERICAN TECHNOLOGY CORPORATION, San Diego, CA (US)

(21) Appl. No.: 11/921,822

(22) PCT Filed: Feb. 9, 2006
(86) PCT No.: PCT/US2006/004953

§ 371 Date: Dec. 7, 2007

Related U.S. Application Data
(60) Provisional application No. 60/651,785, filed on Feb. 9, 2005.

(51) Int. Cl. H04B 3/00; G08B 3/00

(52) U.S. Cl. 381/77; 340/384.1

(57) ABSTRACT

Parametric sound reproduction in high-intensity audio signaling, for example in hailing and warning at relatively large distances, is disclosed in one example by producing a primary audio signal in the audio frequency range, and producing a secondary audio signal in the audio frequency range by modulation of the primary audio signal, wherein the primary signal is chosen to enable an improved effect, for example one of directional reproduction, exploiting greater sensitivity of human hearing, exploiting an efficient or maximum intensity frequency range of a transducer used to reproduce the audio signals, and another parameter effecting distance, intelligibility, or intensity of an audio signal.

### BACKGROUND

The parametric reproduction of sound has been known for decades. A typical application is to modulate an inaudible, i.e. ultrasonic, carrier wave in single or double sideband modes (or equivalently to use a difference of at least two different frequencies) to create an audible sonic signal in a fluid media excited by a transducer emitting said different frequencies or modulated carrier wave. This allows creation of highly directional sound beams in the audible range, for example; and/or creation of virtual sound sources by directing said beams at sonic-reflective surfaces, such as walls, ceilings, or floors of rooms.

A salient feature of such systems typically is that the carrier is inaudible. Furthermore, due to inherent inefficiencies of such parametric sound reproduction, the carrier signal typically must have high energy to create reasonable sound pressure level (SPL) in the audible frequency range.

Also known for decades are high-power sound reproduction devices capable of generating sound at high energy levels. A typical device is an electro-acoustic transducer using an electrostatic or electromagnetic motor, typically coupled to a horn enabling more efficient conversion of electrical energy into sound energy. A typical application is sound reproduction over relatively large distances. For example such systems are used in public address, musical amplification at concerts in large enclosed or open spaces, and communication of voice or tonal audio signals at long distances, or over high levels of background noise.

### SUMMARY

The inventors have recognized that parametric sound reproduction can be valuable in high-intensity audio signaling, for example in hailing and warning at relatively large distances. The invention in one example comprises producing a primary audio signal in the audio frequency range, and producing a secondary audio signal in the audio frequency range by modulation of the primary audio signal, wherein the primary signal is chosen to enable an improved effect, for example one of directional reproduction, exploiting greater sensitivity of human hearing, exploiting an efficient or maximum intensity frequency range of a transducer used to reproduce the audio signals, and another parameter effecting distance, intelligibility, or intensity of an audio signal.

### BRIEF DESCRIPTION OF THE DRAWING FIGURES

Further features and advantages of the invention will be apparent with reference to the following detailed description of example embodiments, taken in conjunction with the appended drawings, wherein:

FIG. 1 is an example hypothetical plot of SPL in dB (logarithmic scale) vs. frequency in Hertz (logarithmic scale) for an output of a hypothetical 1 meter diameter emitter in an in-band generation system in one example of the invention in comparison to the output of another parametric sound reproduction system where the primary tone(s) are outside the 20 Hz to 20 kHz band comprising the audible range;

FIG. 2 is a hypothetical example plot of equal SPL levels in dB for said emitter;

FIG. 3 is a hypothetical example plot of SPL vs. Frequency (both logarithmic) for said emitter showing primary and a first secondary in media output and a second secondary missing fundamental output and a third secondary in-ear output acoustic energy output plots;

FIG. 4 is a schematical perspective view of an example emitter useable in carrying out the invention in one example embodiment;

FIG. 5 is a waveform plot of a signal to be impressed upon the primary audio signal to produce a secondary audio signal in one example, note that there is no scale and no relative scale between any of the drawing figures herein;

FIG. 6 is a waveform plot of a signal to be impressed upon the primary audio signal to produce a secondary audio signal in one example embodiment;

FIG. 7 is a waveform plot of a signal to be impressed upon the primary audio signal to produce a secondary audio signal in one example embodiment;

FIG. 8 is a waveform plot of a signal to be impressed upon the primary audio signal to produce a secondary audio signal in one example embodiment;

FIG. 9 is a waveform plot of a signal to be impressed upon the primary audio signal to produce a secondary audio signal in one example embodiment;

FIG. 10 is a waveform plot of a signal to be impressed upon the primary audio signal to produce a secondary audio signal in one example embodiment; and,

FIG. 10 is a waveform plot of a signal to be impressed upon the primary audio signal to produce a secondary audio signal in one example embodiment;

### DETAILED DESCRIPTION OF PREFERRED EMBODIMENT(S)

It has been recognized by the inventors that in certain applications parametric reproduction can have benefits when the carrier is also in the audible frequency range. For example in long-range acoustic signaling devices, and in sound weapons indented to deter or even incapacitate persons at whom they are directed, an audio signal of large energy can be used. Typically this is made at least somewhat directional, for at least the reason that the sender typically is nearby and does not whish to be subjected to such very loud acoustic signals. Parametric reproduction can enhance the directionality and the effectiveness of devices of these kinds, for example.

In one example a primary audio signal is provided, which can be a modulated carrier signal or two audio signals at different frequencies that are chosen to provide a difference signal. The primary audio signal is “in-band;” that is to say, in the audio range and thus at a frequency within the band of frequencies that a typical human ear can hear. A secondary audio signal is also provided parametrically. This secondary audio signal is also within the audio range. It has been found that the primary signal can be made directional by configuring the emitter to have an emitting surface area which overall is of a diameter large enough to reduce the energy directed transversely to an acoustic propagation axis of the output audio signal and to increase the relative portion of the energy that is directed along the axis. The parametric signal is directional by virtue of is mode of generation as those skilled in the art will appreciate. It has been found that the system can be configured so that a human listener perceives a secondary audio signal of a subjectively perceived strength approaching that of the primary signal. This can be useful in a number of applications, for example hailing and communication, warning and deterrence and other audio applications where audio communication over distance and/or with selectivity (targeting) of the audio energy, (i.e. power and directionality) are important.

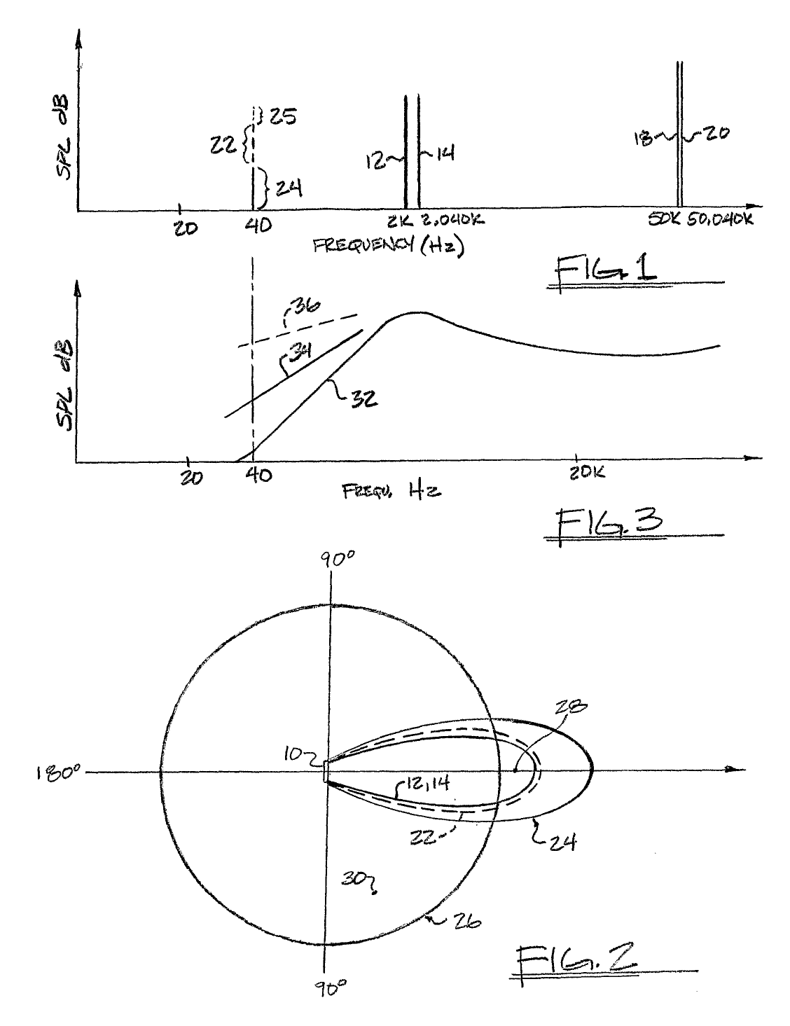

With reference to FIGS. 1 and 3, in one example of the invention an acoustic emitter 10 of about one meter diameter size is used to generate sound in a fluid medium, for example in air. In an example application the emitter can be part of an audio hailing and communication system. The emitter can be a monolithic device having a single transducer or it can be an array of smaller transducers. The transducers transform energy in one form which is not acoustic into an acoustic energy form, and produce an audio output in the medium. For purposes of the present disclosure by example, we will assume an array, about one meter diameter, of electro-acoustic transducers; each transducer having an acoustic motor and a horn optimized for efficiency in the frequency range of about 2 kHz.

Parametric sound reproduction is known, and uses sound created by the emitter at a first frequency range to create sound in the medium in another frequency range. In the example the emitter produces a primary tone, which is itself, further modulated at 40 Hz or two primary tones (for example tones 12, 12a at 2 kHz and 2.040 kHz, respectively ), to produce a difference of 40 Hz. A 40 Hz secondary tone 16 is parametrically produced as a result. This secondary tone is highly directional. In contrast, prior parametric systems typically used primary tones in the ultrasonic range. For example, as shown in FIG. 1 for comparison to the present example, if two tones (18, 18a, at 50 kHz and 50.040 kHz respectively, are produced), a 40 Hz tone such as the tone 16 can be likewise produced. As will be appreciated by those skilled in the art, much more energy is required to produce the same SPL in the secondary tone 16 as the primary tone(s) (e.g. 18, 18a) is/are raised in frequency, and so the conversion efficiency in the present example using two tones in the 2 kHz range (12, 12a) is much higher than would be obtained using an ultrasonic primary signal frequency range (such as 18, 18a).

An advantage of the example where the primary acoustic signal frequency is in-band (say 20 Hz to 20 kHz, typically) is that both the primary (12, 12a) and secondary (16) audio signals can convey audio information perceptible to a human listener. As mentioned, in the example given at least two audible tones would be perceived, one at 40 Hz and one at about 2 kHz.

It will be appreciated that if the primary acoustic signal(s) are modulated or made to differ by an amount corresponding to a voice audio signal, for example, a listener can be exposed to both a tone audio signal, which can be a warning tone (the primary audio signal), and also to a voice signal (the secondary audio signal) and both can be discernable at the same time by the listener. In another example the primary signal can be tones and the secondary signals can be a low frequency beat tone, the combination of which can be made to be quite uncomfortable at high energy levels. Such combinations of signals can be used to warn and determine the intent of persons approaching the emitter 10. This can be done for example by giving warning tones, voice information, deterrent tones, and depending on circumstances one or more of these can be given at very high energy levels at the listeners location, for example up to and even well past the typical pain threshold in humans. In another example an attention-getting or deterrent tone (primary) can accompany a secondary (parametrically reproduced) audio signal including confusing or frightening audio information such as the sound of gunfire, approaching helicopters, incoming rockets, or ballistics, or the like. Such examples can be used in a system in a point or area defense application, for example.

It has been found that in addition to the measurably perceivable secondary audio signal produced parametrically in the medium, it has been found that a further parametric reproduction effect occurs, apparently, by a perceived effect occurring entirely within the human ear, or at least is perceived in the audio sensing mechanisms of a human listener, essentially directly, rather than as pressure waves created in the medium and carried to the ear. At least a part of this effect perceived by human listeners could therefore be related to the phenomenon known as “Tartini tones.” It has been found that when the primary signal is in-band (audible) that the in-ear parametric effect (or in other words, the portion of the secondary signal perceived by a human listener by virtue of this in-ear effect) is quite strong. Moreover, unlike the case where the primary audio signal is in the ultrasonic frequency range, when the primary signal is in band the in-ear parametric effect does not appear to be as dependent on variable factors such as orientation of the ear canal with respect to the axis of propagation of the audio signal, for example, and it has been found that the phenomenon will occur relatively reliably as long as the listener's ear is within the beam of the primary sound signal, regardless of which way the ear canal is pointed with respect to the sound source.

In FIG. 1 a portion 22 of the parametric secondary signal 16 is due to this in-ear effect, and is designated as such an shown as the dashed portion thereof. An “in media” portion 24 of the parametric secondary signal 16 is shown solid in the figure. The combined height represents the perceived SPL at the listener's inner ear. The in-ear parametric demodulation and missing fundamental phenomenon (discussed further below) possibly giving rise to the enhanced perceived strength of the secondary audio signal is/are not fully understood, but the effect of a strong secondary signal perception is empirically verifiable using human test subjects. Moreover quantification is difficult but it has been found that the “in-ear” portion of the secondary signal perceived can be a significant portion of the entire “perceived” SPL at the listener's inner ear when the primary signal is in-band.

Thus the secondary audio signal usable in the system can include an “in-medium” parametric portion 24, and an “in-ear” portion 22. As mentioned above and as represented in the figures, the combination of these portions can produce a perceived loudness that approaches that of the primary signal 12, 12a at least to a human hearer subjected to the output of the array 10, for example at a point 28 on axis at a distance from the emitter. This effect has been observed as surprisingly pronounced, the lower frequency being often reported as perceived more strongly than the higher frequency in the signal received by human listeners tested.

As illustrated in FIG. 2, the directionality of the parametrically reproduced audio can mean that at greater distances from the emitter 10 the in-media portion 24 of the secondary signal can be well heard. Moreover the 40 Hz secondary signal is much more directional than would be the case if it were produced directly, illustrated by the plot 26 of such a signal directly generated, which is essentially omni directional due to its low frequency. It will be appreciated at a location 28 far from the emitter a listener would perceive the primary signal (12, 12a if two signals separated by 40 Hz are used as in the example), as well as the parametric signal (16 in FIG. 1) which includes the in-media portion 24 and in-ear portion 22. At an off axis location 30 outside the primary and secondary audio beams these signals would be perceived to be of very much less energy and both measurable SPL and perceived loudness are down considerably.

With reference to FIG. 3, a plot of the emitter 10 output primary 32 and that of the in-media parametric signal 34 and the combination of in media and in-ear parametric signal (additive) 36 for the example emitter 10, taken together illustrate that higher SPLs in the lower frequency ranges are achievable using this methodology for the same output energy to the transducer(s) of the apparatus used to create the in-band parametric signal. Taken with the plot shown in FIG. 2, this illustrates that at greater distance where the parametric signals carry due to their higher directionality the SPL of the secondary signals (in media and in ear) can become high with respect to the primary signal. With reference to FIG. 1 as well, it will be appreciated that the combined effect of the in-ear and in-media parametric demodulation can give SPLs approaching that of the primary signal(s).

With reference again to FIG. 1, in another example embodiment the secondary audio signal 16 can be further enhanced using a known phenomenon often referred to as the “missing fundamental.” This is an effect produced when two or more harmonics are reproduced in the fluid medium and perceived by a human. It is known that when a listener hears a set of harmonic tones the human brain apparently “fills in” the fundamental frequency and that as a result this fundamental frequency tone is subjectively perceived by the listener, even though the fundamental is not actually produced in the media, (e.g. air) in which the sound is reproduced. This missing fundamental effect can be used in the invention example system to further enhance the perceived sound, and is represented by the portion 25 of the secondary signal 16 shown.

In the illustrated example, audible tones (e.g. 12, 12a) in the 2 kHz range (and if desired other harmonics (not shown) in the audible range) can be provided, and their frequency can be selected so that the “missing fundamental” created coincides with or enhances and reinforces the secondary audio signal 16 so as to make it be perceived more strongly by a hearer. Thus a further incremental enhancement of the secondary audio signal can be provided in this example. In the illustrated example the portion 25, which represents the “missing fundamental” portion of the perceived audio signal, adds incrementally to the perceived strength (height) of the signal.

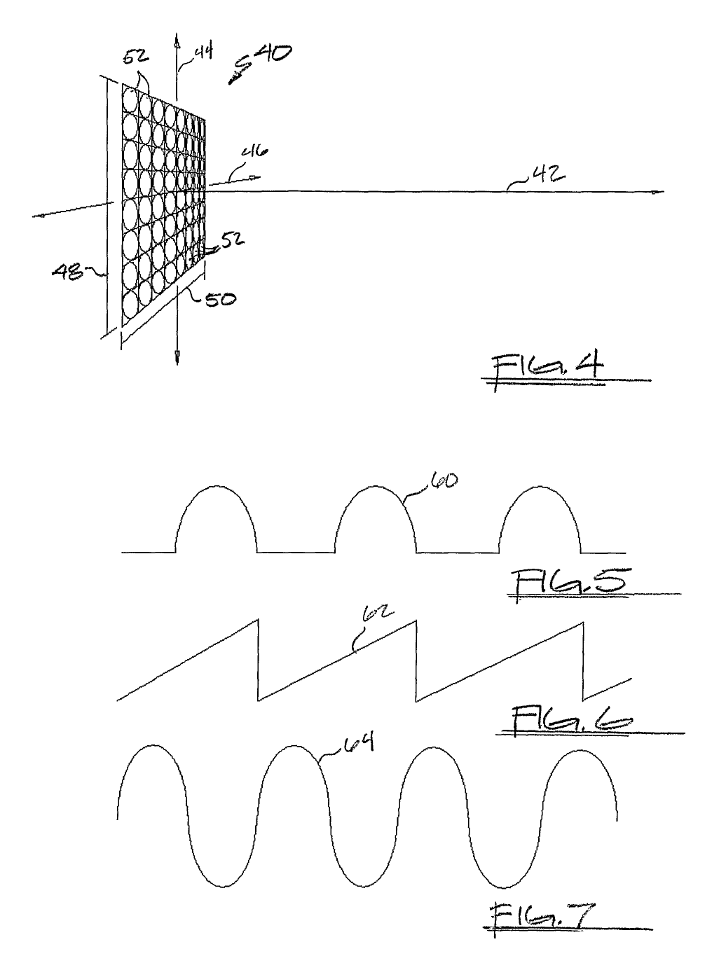

With reference to FIG. 4, an example high intensity acoustic emitter 40 can be configured so that certain frequencies are directionally reproduced along an acoustic axis 42. In one embodiment the emitter is made large enough in directions 44, 46 transverse to the axis so that its dimensions 48, 50 are in the range of at least three to four times the wavelength of the lowest frequencies to be directionally reproduced. For purposes of description of the invention the extent of the emitter transverse to the axis will be called its aperture. The larger the dimensions of the aperture, the more directional the output, for a given frequency. As mentioned above, at low frequencies the dimensions would need to be very large indeed; whereas at about 2 KHz and above, directionality can be obtained in this way from a reasonably sized emitter. It does not matter if the emitter is a single transducer, e.g. a large planar-magnetic device, or an array of many smaller transducers, e.g. conventional speakers or piezo-electric transducers.

In another embodiment, where the emitter 40 is made up of a plurality of smaller transducers 52, the transducers can be disposed so that they are one-half wavelength apart at a selected frequency. This makes the device even more directional near that frequency, or allows the aperture can be smaller for a given frequency, as the output from the individual transducers tend to cancel in transverse directions (e.g. 44, 46). In another embodiment, the transducers 52 can be individually phase controllable, so that they can be made to cancel in transverse directions, but not cancel in the direction parallel to the axis 42 of desired output. In either case, bands of frequencies are made directional, or can be made directional through phase manipulation. Particularly when a warning or deterrent acoustic signal is to be reproduced, rather than voice, very loud and very directional signals are enabled at selected frequencies.

It has been found that by placing a carrier acoustic signal, the “primary” signal 12 or 14 referred to above and shown in FIG. 1, for example, at a selected frequency to be directional from the emitter 40, and then modulating this carrier frequency by another acoustic signal, typically of another, much lower, or more complex, frequency configuration, that information conveyed by the modulating signal can be conveyed directionally from the emitter 40 along the axis 42 in a directional manner. While this restates what has been said above, it is meant here to convey a more general application of the concept. Anything from a relatively simple low frequency tone, as described above, to voice, and other very complex signals can be transmitted directionally in this way. Another way of looking at the implications of the invention is that we take a primary signal, which is a single frequency or a band of frequencies chosen so as to be directional when used with the emitter 40, and we distort that primary signal. The secondary audio signal we want to convey is essentially carried on the distortion of the primary signal. It has been found that even voice can be conveyed, for example using a 4 KHz carrier, AM modulated at about 0.7-0.8 modulation index, directionally in this way.

As mentioned above, and as will be appreciated by those skilled in the art, AM manipulation of a carrier can be done in a number of ways, single sideband upper or lower, double side band. Other forms of modulation, such as pulse width, and (within the constraints of the available frequency band directionally reproduced) FM, etc. can also be employed instead of or in combination with AM, depending on the type of information to be conveyed parametrically using an audible carrier.

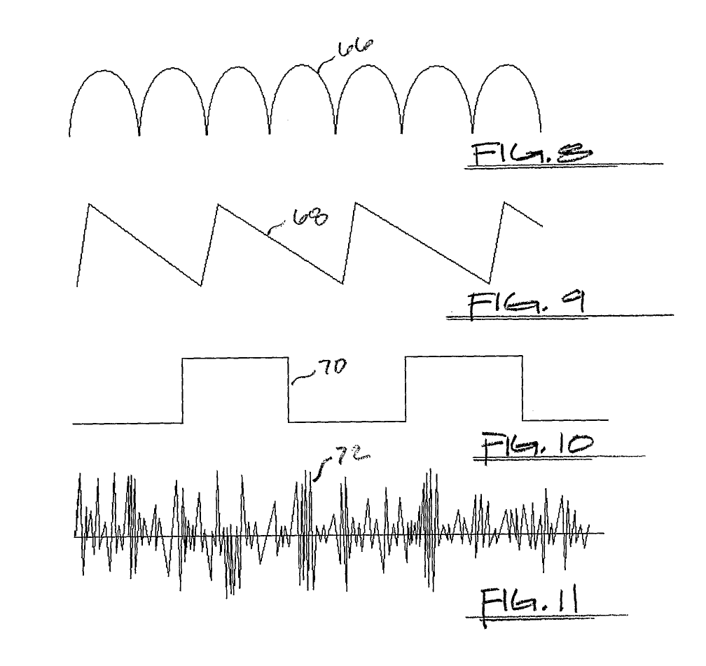

Turning now to the example of a warning or deterrent tone, and with reference to FIG. 5, it has been found that for making a secondary tone perceived more loudly, using a half-wave (rectified) waveform 60 as the modulation signal to be impressed upon the carrier produces superior results. For example if the carrier is at 3 KHz, and the modulation signal is at 30 Hz, a very strongly perceived beat tone of 30 Hz is produced, it has been found to essentially overwhelm the carrier in perception of human test subjects. In other words, they perceive a 30 Hz tone at least as strongly as the 3 KHz primary signal. Moreover harmonics can be added, and these also naturally occur using this technique. In another embodiment an un-rectified tone of 15 Hz, e.g. using the waveform 64 shown in FIG. 7, is used to create a 30 Hz beat tone secondary output by modulation. In another embodiment a rectified 30 Hz tone of saw tooth waveform 62 is used, as shown in FIG. 6. These schemes can be used to create alerting, alarming, and annoying tonal effects, particularly at high intensities of the carrier. Since the carrier stays at 3 KHz in this example, a frequency within the band of best sensitivity for human hearing, and which can be in the band of most efficient reproduction by the transducer used when piezo-electric motors are employed, this can produce very loud outputs of primary signals carrying secondary signals, more directionally and more efficiently, and thus effectively at longer distances from the emitter (40 in FIG. 4).

Other modulating waveforms, such as a rectified sine wave 66 shown in FIG. 8, a triangle waveform 68 of some sort such as the example shown in FIG. 9, or square wave 70 as shown in FIG. 10, can be used. These waveforms themselves can be modulated, for example the waveform of FIG. 10 can be pulse width modulated to convey coded information in this way by the secondary signal carried on a constant frequency primary signal carrier, all in the audio frequency band.

It has been found that audio information, such as code, voice, and the like, can be modulated onto the in-audio band carrier, and can likewise be directionally conveyed with great power. Moreover, highly disconcerting, jarring, and therefore attention-getting or deterring, audio effects can likewise be produced at relatively large distances. With reference to FIG. 11, a complex audio signal 72, such as voice, can be modulated onto the carrier as described above. This likewise can be directionally reproduced. While voice on a 4 KHz carrier does not dominate over the carrier, it is nonetheless intelligible and is heard along with the primary signal. Again, in that example in effect the information communication is carried by the distortion of the initially pure carrier tone at say 3-5 KHz in one example. As mentioned this can be made to coincide with both the most sensitive range of hearing and most efficient range for reproduction in certain transducers. This gives rise to being able to project the information directionally and over greater distances.

As will be appreciated, using a given carrier (primary) audio signal, other modulation schemes (FM, Pulse width, phase, etc.) in addition to AM modulation to impose a secondary signal on an audio band primary one is possible. Again, distortion is being used to convey the signal. When the secondary signal is voice, it does not necessarily sound like natural voice, for example, but depending on modulation scheme, modulation index, carrier frequency, intelligible voice communication has been found to be possible. In fact it has been found that voice is surprisingly intelligible, given the limitations of the scheme, and carries long distances due to its improved directionality over conventional voice, which sees dropouts of the lower frequency components at larger distances.

Moreover, combinations of AM, FM, Pulse Width, and Phase modulation can be used, different combinations of modulation giving rise to different effects. It will also be appreciated that the few example waveforms given herein are only exemplary of the myriad different forms that can be employed, superimposed, etc. in modulating a carrier, or comprising the carrier itself, which does not necessarily have to be sinusoidal.

Attention getting audio signals, alarms, annoying and deterrent effects, communication of information by code, by voice, etc. all have been found to be possible in these examples. The use of in-band parametric sound reproduction can give rise to systems that have desirable properties in many applications, including those mentioned above. They are highly directional, and they allow at least two separate audio “channels” over which to convey information, provide warning, provide deterrent effect, etc.

While the invention has been disclosed in terms of illustrative examples, it is not intended to be limited to the above examples.

1. A method for communication of a low frequency tone in a directional manner at high intensity, comprising:
Providing an emitter having an acoustic output along an acoustic axis;
Configuring said emitter to have an output sufficiently directional that there is at least a six dB drop in intensity from zero to 45 degrees off axis, and a primary audio output band pass characteristic limiting the low frequency output and reproducing strongly at higher frequencies;
Providing a parametric audio output wherein the carrier frequency is in the audio range, by single or double sideband modulation of a single carrier or equivalently by providing two carriers separated by the lower frequency to be reproduced parametrically,
Whereby a directional high frequency audio signal carries a lower frequency audio signal reproduced parametrically.

2. A method as set forth in claim 1 further comprising the step of modulating the carrier signal by at least one of frequency and pulse width in addition to amplitude, 1.

3. A method as set forth in claim 1 further comprising the step of configuring said emitter to have a lateral extent transverse to said axis of at least three times the wavelength of the lowest carrier frequency.

4. A method as set forth in claim 1 further comprising the step of configuring the emitter to have an array of emission regions separated by a distance coordinated with a selected frequency to provide sideways cancellation of acoustic output by phase interference and forwardly propagate in phase to strengthen acoustic output on axis.

5. A method as set forth in claim 1, further comprising the step of selecting the carrier frequency and transducer used in the emitter so that one of efficiency and continuous output intensity can be maximized for the emitter at the carrier frequency.

6. A method as set forth in claim 5, wherein the step of selecting the carrier frequency and transducer type includes the further steps of selecting a piezo-electric transducer with a resonant frequency range within the range to which human hearing is most sensitive, and selecting the carrier frequency to be within the resonant frequency range.

7. A method for communication of a primary and secondary audio signal in at least one of a directional and high-intensity manner; comprising the steps of:
providing an emitter having an acoustic output along an acoustic axis at a high intensity,
providing a parametric acoustic output from said emitter wherein a primary audio signal is in the audio range, and is modulated to produce a secondary audio signal in the audio range, and
selecting the primary audio signal to be in a frequency range that is at least one of: a) able to be directionally reproduced by the emitter; b) within a range of frequencies to which human hearing is most sensitive; and, c) within a range of frequencies wherein the emitter can produce its most intense output for a given power input.

8. A directional sonic emitter for hailing, warning, and deterrence, comprising:
An emitter having an acoustic axis and acoustic emission surface aperture transverse to the acoustic axis, said emission surface aperture having a dimension transverse to the acoustic axis at least three times the wavelength of the lowest sound frequency to be directionally reproduced;
said emitter having at least one transducer configured for converting energy in a first form into acoustic energy comprising a compression wave train in an air medium
a power amplifier configured for powering said emitter, said amplifier taking an acoustic signal and enabling it being reproduced much more powerfully in said emitter, said power and emitter being configured to direct most energy into a frequency band which overlaps that frequency to which the human ear is most sensitive.
